(19) United States
(12) Patent Application Publication
(10) Pub. No.: US 2014/0016476 A1
(43) Pub. Date: Jan. 16, 2014

(54) METHOD FOR OPERATING A FLOW-BASED SWITCHING SYSTEM AND SWITCHING SYSTEM

(71) Applicants: Thomas Dietz, Weingarten (DE); Nico D'Heureuse, Heidelberg (DE); Hans-Joerg Kolbe, Darmstadt (DE)

(72) Inventors: Thomas Dietz, Weingarten (DE); Nico D'Heureuse, Heidelberg (DE); Hans-Joerg Kolbe, Darmstadt (DE)

(73) Assignee: NEC EUROPE LTD., Heidelberg (DE)

(21) Appl. No.: 14/007,014

(22) PCT Filed: Mar. 24, 2011
(86) PCT No.: PCT/EP2011/001480

§ 371 Date: Sep. 24, 2013

(51) Int. Cl. H04L 12/721

(52) U.S. Cl. CPC H04L 45/38
USPC 370/238; 370/392

(57) ABSTRACT

A method for operating a flow-based switching system in a network, including at least one network node designed to transport incoming network packets, in particular a switch (20) or a router, wherein the incoming network packets are matched to flows according to predefined policies, wherein a dynamic flow table (40)—primary flow table (50)—containing information about the flows' properties is computed inside the network node or externally and stored in a memory of the network node, is characterized in that another dynamic flow table (40)—backup flow table (60)—is computed and maintained in parallel, wherein the backup flow table (60) is more coarse grained than the primary flow table (50), and wherein the network node switches between employing the primary flow table (50) or the backup flow table (60) depending on the status of predefined observables. Furthermore, a corresponding flow-based switching system is disclosed.

The present invention relates to a method for operating a flow-based switching system in a network, including at least one network node designed to transport incoming network packets, in particular a switch or a router, wherein said incoming network packets are matched to flows according to predefined policies, wherein a dynamic flow table—primary flow table—containing information about said flows' properties is computed inside said network node or externally and stored in a memory of said network node.

Furthermore, the present invention relates to a flow-based switching system, including at least one network node designed to transport incoming network packets, in particular a switch or a router, wherein said system comprises computation means for matching incoming network packets to flows according to predefined policies and for computing a dynamic flow table—primary flow table—containing information about said flows' properties, and a memory for storing said primary flow table.

Flow based routing/switching is a mechanism nowadays rather frequently employed in networks, which allows fine granular control of network traffic. The specific characteristic of flow-based routing/switching is that packets are not only forwarded depending on their destination, but also on other properties, such as origin, QoS requirements, cost, etc. In this context a flow is defined as a collection of packets, which share at least one, or typically a set of common properties. For instance, a flow could include e.g. packets that all have the same source IP address and the same destination IP address (“SrcIP, DstIP”). In general, the more fine-granular the traffic should be controlled, the more different flows need to be handled by the switching system.

To match incoming packets to flows, the switching system must keep information about the flows' properties in a local memory. More specifically, for all flows passing through the switching system that are subject to flow-based handling this memory stores information related to specific flow characteristics. To enable high-speed switching, often a special type of memory, denoted “TCAM” (Ternary Content-Addressable Memory), is required. As TCAM is very complex and expensive, its size on a switch is usually very limited.

The limitation of flow memory leads to problems when a large number of flows pass through a switching system. Once the memory of the switching system is full, the switching system cannot simply add new flow entries. According to existing technology there are several ways the switching system can deal with this problem:

According to a rather straightforward approach the switching system can simply reject a new flow entry in case of the memory of the switching system is completely full. As a consequence, the packets of this flow will not be processed correctly or will not be processed at all.

In a more sophisticated implementation of the switching system, the network equipment designed to transport network packets of different flows may delete some existing flow entries to free up memory, and it may then insert the new flow. The deletion of flow entries may be performed according to different policies. For instance, the switching system might delete i) flows with lower priority, ii) older flows, or iii) flows randomly. However, this will strongly impact the switching system's forwarding performance, and depending on the implementation it is rather likely that packets will be dropped. In some implementations (e.g., OpenFlow), the switching system will ask a flow-controller (e.g., OpenFlow-controller) how to process the packets. As this will happen for all incoming packets for which no flow entry exists in the switching system's memory, the controller can easily be overloaded.

According to a further alternative the switching system uses a slower (but larger) secondary memory when the primary memory is full. However, in this approach the forwarding speed of the switching system will be strongly reduced.

All of the above methods will impact the performance of the network and lead to non-optimal and often un-deterministic network states. Although the problem can be reduced by increasing the total flow memory, this memory will always be limited and the switching system will eventually run out of memory.

Some flow based switches, e.g., the NEC OpenFlow Switch IP8800/53640-48TW-LW have support for secondary or emergency flow tables. These secondary or emergency tables are static, i.e., they are configured at startup-time via command line interface and they are only activated when the connection to the (OpenFlow) controller is lost. Those tables therefore can ensure network operation when the control connection is lost, but do not solve the problem of full flow tables described above.

Another related prior art tool is the configuration protocol Netconf together with the corresponding configuration databases. These databases only contain static information, and they are not intended for dynamic operation of the device. Dynamic information, such as forwarding information and flow entries, are computed at run-time and cannot be pre-provisioned.

MPLS (Multiprotocol Label Switching) is a mechanism applied in telecommunication networks for directing packets from one network node to the next with the help of labels. It is able to provide a primary and a backup path in the case of redundant LSPs (Label Switched Path) or “Fast ReRoute” (FRR) where e.g. a link is protected. MPLS provides the paths and forwarding entries but does not provide a dynamic mapping of incoming traffic to such paths as OpenFlow does. Mapping is usually done either with static or dynamic routing. If a link or path is down, the classified traffic will be redirected to another (virtual) backup interface/path. Changing to a backup path or doing a fast reroute only covers error like line errors or loss of connection. It cannot cope with situations where local resources on a network node are exhausted.

It is therefore an object of the present invention to improve and further develop a method for operating a flow-based switching system in a network and a switching system of the initially described type in such a way that even in the event that local resources on a network node, which are available for deciding on the transportation of incoming network packets, are getting exhausted the performance and operational characteristics of the network node are maintained as high as possible.

In accordance with the invention, the aforementioned object is accomplished by a method comprising the features of claim 1. According to this claim such a method is characterized in that another dynamic flow table—backup flow table—is computed and maintained in parallel, wherein said backup flow table is more coarse grained than said primary flow table, and wherein said network node switches between employing said primary flow table or said backup flow table depending on the status of predefined observables.

Furthermore, the aforementioned object is accomplished by a flow-based switching system comprising the features of claim 18. According to this claim such a switching system is characterized in that it further comprises computation means for computing another dynamic flow table—backup flow table—, which is maintained in parallel, wherein said backup flow table is more coarse grained than said primary flow table, and decision means for performing a switching between an operational state in which said primary flow table is employed and an operational state in which said backup flow table is employed, depending on the status of predefined observables.

According to the present invention it has been recognized that even in the event that a network node's resources available for flow table storage are getting exhausted, high performance of the network node with respect to packet transport can be maintained by calculating and switching to a dynamic secondary flow table, which functions as backup flow table. In particular, the predefined observables may include the utilized capacity of the memory of the network nodes. A use case beyond resource exhaustion of the local network node's memory is when a certain amount of flows is installed to redirect packets to an internal or external processing unit that has restricted computing power.

The present approach tries to replace the existing flow state with a more coarse grained but less memory consuming approach.

Although an operation with the backup flow table comes along with limited functionality due to the coarser grained character of the backup flow table compared to the primary flow table, the system experiences an operational performance in case of resource exhaustion, which is significantly improved with respect to prior art solutions. In particular, flow-based network systems, such as OpenFlow based ones, are made more reliable by preventing outages caused by exhaustion of resources, e.g. memory, available for flow table storage. It is noted that the overall performance depends on the calculation algorithms employed for primary and secondary flow table calculation.

The present invention calculates a dynamic backup flow table that reflects the current state of the network in a more aggregate way as described above. A static table as it is employed in some prior art approaches cannot accommodate for that.

For instance, Netconf and configuration databases in contrast lack a mechanism like a trigger that could start the upload of an emergency configuration and even if such a trigger would be given the provisioned configuration data could not contain dynamic data like the backup flow table described in the present invention.

Although a flow-based switching system according to the present invention requires additional calculation resources for pre-calculation of the backup flow table, it significantly reduces usage of local resources when to many flows need to be handled on a device. The deployment of the backup flow table reduces e.g. the granularity of QoS handling or ceases load balancing but does not reduce to total throughput of the network itself.

According to a preferred embodiment it may be provided that the process of switching from the primary flow table to the backup flow table is triggered by an event of reaching a predefined threshold value indicating exhaustion of any of the predefined observables, e.g. the available memory. Alternatively or additionally, it may be provided that the process of switching from the primary flow table to the backup flow table is triggered by an event indicating an expected degradation of network and/or service performance caused by the amount of flows being redirected to a network node-internal or external processing function with restricted computing power.

According to another preferred embodiment it may be provided that the backup flow table is activated in case the memory and/or other local flow-related resource constraints prevent the network node from operating the said primary flow table. To this end certain conditions, e.g. a threshold for the percentage of memory utilization may be predefined and regularly checks may be performed whether the conditions are fulfilled. For instance, in a specific implementation an activation of the backup flow table may be executed in the event that the flow entries of the primary flow table require a storage capacity that exceeds the amount of 99% of the overall available storage capacity of the employed memory.

In a specific embodiment the backup flow table may be stored in the same memory area of the memory as the primary flow table, resulting in the advantage that only a single memory is required. In such case the flow entries of the backup flow table may be given a lower priority than the flow entries of the primary flow table. When an exhaustion of flow entry memory is experienced, the priority of the secondary flow entries ease may be increased above the priority of the primary ones in order to activate the backup flow table. Alternatively, the flow entries of the primary flow table may just be deleted.

In another embodiment the primary flow table may be stored in a first memory area of the memory, whereas the backup flow table is stored in a different second memory area of the memory. This separate second memory area may be slower and cheaper than the one employed for the primary flow entries, which are stored as usual in their (typically very fast) memory area. In such case, switching between an operation employing the primary flow table and an operation employing the backup flow table may be performed by deleting the primary flow table from the first memory area and by copying the backup flow table from the second memory area to the first memory area.

With respect to a particularly reliable operation, it may be provided that the activation and/or deactivation of the backup flow table is triggered by a controller. Alternatively, activation and/or deactivation may be controlled by a remote network node or by a neighbor network node.

In case of the deployment of an external controller, the external controller may control a network equipment's primary flow table (e.g. an OpenFlow switch which is controlled by an OpenFlow controller) and may at the same time keep a backup flow table. In such implementation activation and/or deactivation of the backup flow table can be performed in such a way that the controller deletes the primary flow entries of the network equipment and saves the backup flow entries that were computed beforehand into the network equipment. It may be provided that the controller calculates a corresponding backup flow table in parallel to calculating the primary flow table. Alternatively the controller may do this on demand, e.g. when a network equipment runs out of memory. The controller can either proactively monitor the network equipment to detect a low memory state, or can be requested by the equipment to replace a certain number or all primary flow entries.

In a more global approach it may be provided that the external controller forces all network node within a network domain to perform coordinated switching from the primary flow tables to the backup flow tables, or vice versa. For instance, the backup flow tables may be activated/deactivated network-wide in a synchronized fashion. Likewise, the calculation of backup flow tables may follow a more global approach. Instead of calculating backup flow tables per each network node individually, it may be provided that the calculation is performed per group of network nodes, or even for the network as a whole. It is noted, however, that a full network approach as described above requires the full review on the network (as in any OpenFlow based solution).

With respect to an efficient handling, a backup flow table may be pushed to a network node upon request and/or trigger events. In a preferred embodiment the backup flow table may be proactively pushed to the respective network nodes.

With respect to the creation of a backup flow table different approaches are envisioned. For instance, it may be provided that a backup flow table is designed such that one flow entry of the backup flow table substitutes and/or aggregates several flow entries of the primary flow table. As a consequence, the backup flow table it is coarser grained than the primary flow table, i.e. it provides limited functionality, however coming along with the advantage of less memory capacity.

In another embodiment it may be provided that network equipment that uses different QoS classes to prioritize some flows over others for the same destination and/or source could it give up prioritization of flows and treat all flows with the same QoS and reduce the number of flow entries in this way. As an example, there could be a flow-based rule to map different flows into different classes for VoIP traffic. An aggregated rule might map all VoIP packets into the same class.

A network equipment that does load balancing and thus creates flow entries for forwarding flows to a number of different destinations all fulfilling the same service based on their source MAC or IP address could stop doing load balancing and forward all traffic to the same destination. This would save the flow entries for the other load balancing destinations.

Usually a network operator would try to forward traffic to those peers where the monetary costs for forwarding traffic are least. This leads to a variety of flow entries for different destinations and different peers. If the network equipment runs out of flow entry memory it could reduce the number of flow entries by forwarding all the traffic to the same peer.

When traffic should be monitored, e.g., for accounting, flow entries have to be setup in order to copy the traffic to the monitoring point. For a fine granular monitoring, these entries are quite numerous. In case, the system runs out of memory, the entries can be replaced by fewer, lower granular flow entries.

There are several ways how to design and further develop the teaching of the present invention in an advantageous way. To this end, it is to be referred to the patent claims subordinate to patent claims 1 and 18 and to the following explanation of preferred examples of embodiments of the invention, illustrated by the figures. In connection with the explanation of the preferred examples of embodiments of the invention by the aid of the figures, generally preferred embodiments and further developments of the teaching will be explained. In the drawings

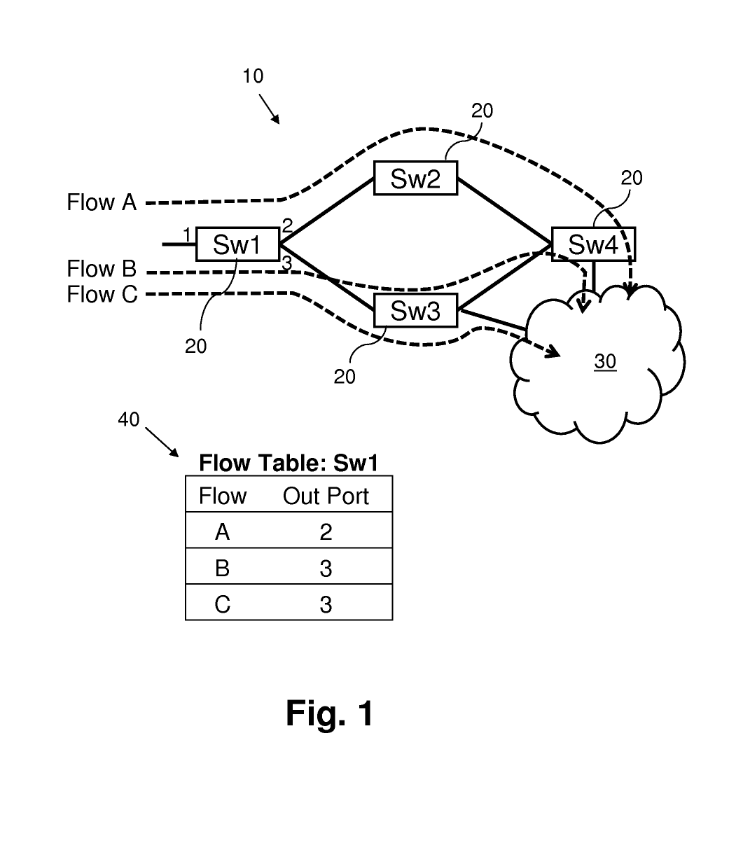

FIG. 1 is a schematic illustration of a switching system according to prior art together with an exemplary flow,

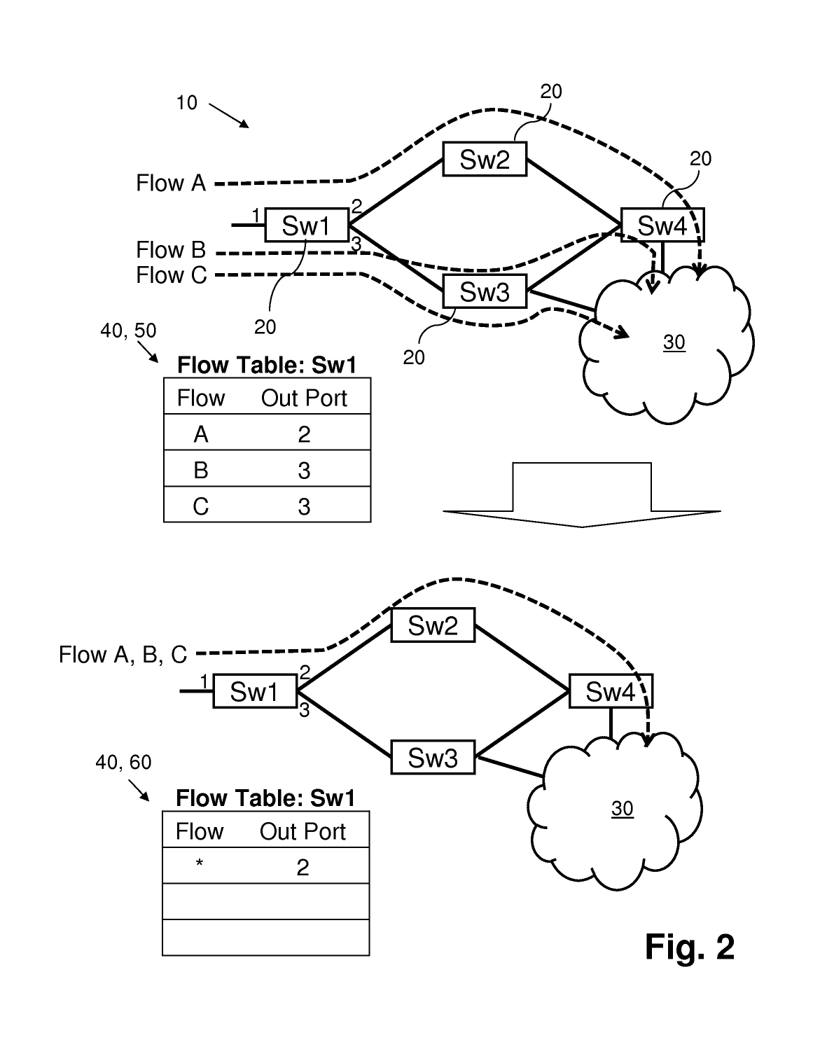

FIG. 2 is a schematic view of a first embodiment of a switching system according to the present invention illustrating the process of switching from a primary flow table to a backup flow table,

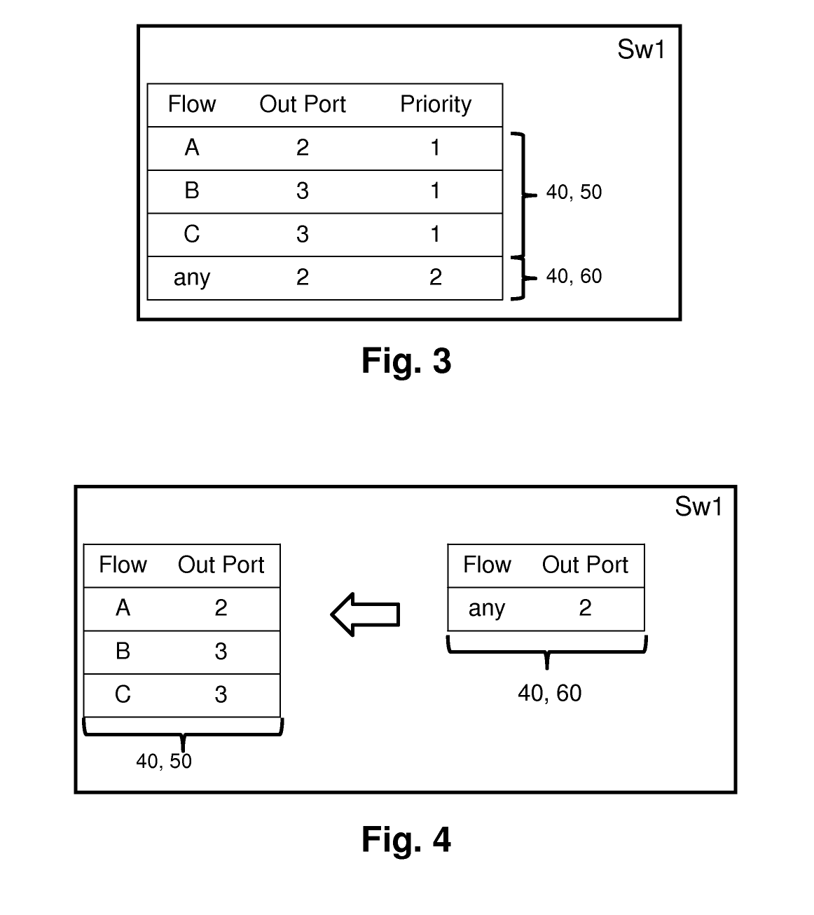

FIG. 3 is a schematic view of a second embodiment of a switching system according to the present invention employing flow tables with prioritized flow entries,

FIG. 4 is a schematic view of a third embodiment of a switching system according to the present invention with the backup flow table being copied from a separate memory, and

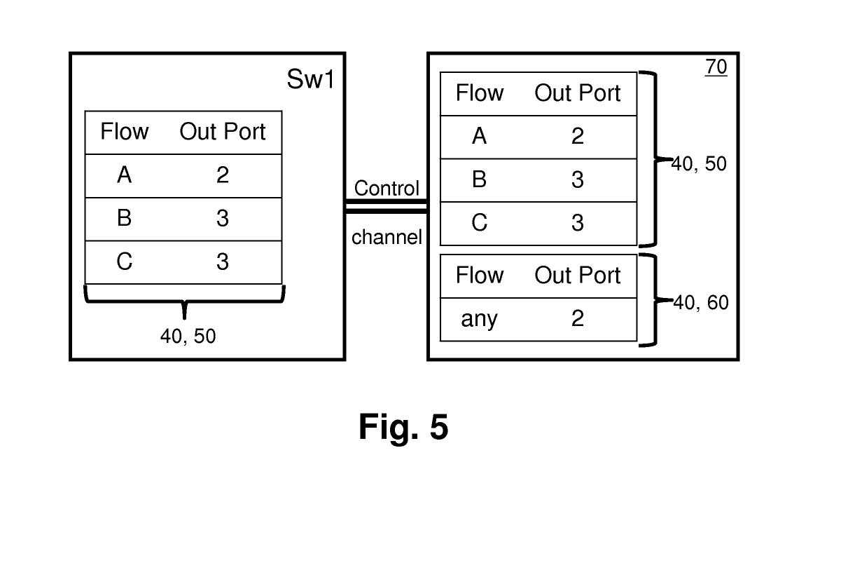

FIG. 5 is a schematic view of a fourth embodiment of a switching system according to the present invention with the backup flow table being kept in an external controller.

A typical switching system as known in prior art is illustrated in FIG. 1. The illustrated switching system 10 includes a plurality of switches 20, from which four switches—Sw1-Sw4—are exemplary shown. Connections between the switches 20 as well as to a destination network 30 are indicated by solid lines. The paths along which flows are transported are indicated by dashed lines.

In FIG. 1 three flows—Flow A, B, and C—are depicted, wherein a flow is defined by a set of common properties. Then, all packets that fulfill the set of common properties belong to the respective flow. In FIG. 1 the three flows are arriving at switch Sw1 and all have to be transported to the destination network 30. Switch Sw1 has one ingress port 1, where the three flows come in, and two egress or out ports 2 and 3. The decision of whether to transport a flow via out port 2 or out port 3 is made on the basis of information contained in a flow table 40, which for switch Sw1 is also depicted in FIG. 1. The flow table 40 is calculated and stored in a memory by switch Sw1 in a dynamic fashion. In this regard it is important to note that basically the flow table 40 can also be calculated outside of switch Sw1. In the specific embodiment of FIG. 1, flow A is transported via out port 2, whereas flows B and C are transported via out port 3.

The limitation of memory available for flow tables, which basically is always given independent of the actual size of the memory, may lead to problems, in particular in the event that a large number of flows pass through the switch. Since once the memory is full, the switch cannot simply add new flow entries. In order to solve these problems with no (or almost no) impact on the performance of the network, the present invention proposes the replacement of the existing flow state with a more coarse grained but less memory consuming flow state, as will be explained in more detail with respect to the following embodiments of the invention in connection with FIGS. 2-5.

The upper part of FIG. 2 corresponds with the scenario of FIG. 1 and illustrates the same switching system 10 with the same flows and the same flow table 40 for switch Sw1 as shown in FIG. 1. This existing flow table 40 is denoted as primary flow table 50 hereinafter.

As shown in the lower part of FIG. 2, the switch Sw1 computes more coarse grained flow entries than the ones contained in the primary flow table 50 and stores those flow entries in a new flow table 40 denoted secondary or backup flow table 60. For instance, one flow entry of the backup flow table 60 may substitute or aggregate several flow entries of the primary flow table. Again, it is to be noted that the computation of the backup flow table may also be performed in another network node, e.g. by a centralized controller.

In the embodiment of FIG. 2, Flows A, B and C contained in the primary flow table 50 are aggregated to a single flow (denoted ‘*’), which will be transported via out port 2. When the switch Sw1 starts running out of memory for flow entries, the backup flow table 60 will substitute the primary flow table 50 to keep up full speed in packet transport. The aggregation/substitution causes a less fine-grained flow-based differentiation, but allows the packet/frame forwarding still to continue.

FIG. 3 again relates to the same switching system 10 and flow scenario as described in connection with FIGS. 1 and 2, and it illustrates an embodiment according to the present invention in which flow tables 40 with prioritized flow entries are employed. The illustrated switch Sw1 comprises as memory a TCAM (Ternary Content-Addressable Memory) in which the flow tables 40 with prioritized flow entries are stored. The primary flow table 50 includes three flow entries for Flows A, B and C, according to which Flow A is transported via out port 2, whereas Flows B and C are transported via out port 3.

In addition to the flow entries of the primary flow table 50, switch Sw1 computes a backup flow table 60 with secondary flow entries, but gives them a lower priority than the primary flow entries. The secondary flow entries are saved in the same memory area where the primary flow entries are stored. When the network equipment runs out of flow entry memory it either raises the priority of the secondary flow entries above the priority of the primary ones and then deletes the primary flow entries or only deletes the primary flow entries. Depending on the network equipment, it might be possible to have a fast switch from primary to secondary entries in a different manner (e.g., separate tables on OpenFlow specification 1.1).

FIG. 4 again relates to the same switching system 10 and flow scenario as described in connection with FIGS. 1 and 2, and it illustrates an embodiment according to the present invention with the backup flow table 60 being copied from a separate memory. The switch Sw1 computes the secondary flow entries and stores the entries in a backup flow table 60 located in a separate memory area. This memory area may be slower and cheaper than the one employed for the primary flow entries. The primary flow entries are stored as usual in their (fast) memory area, for instance a TCAM. When the switch Sw1 runs out of flow entry memory, it deletes the primary flow table 50 and performs a bulk memory copy of the secondary flow table 60 from the slow memory area to the fast flow table memory, where it substitutes the primary flow table 50.

FIG. 5 again relates to the same switching system 10 and flow scenario as described in connection with FIGS. 1 and 2, and it illustrates an embodiment according to the present invention with the backup flow table 60 being kept in an external controller 70. A control channel 80 is established between switch Sw1 and controller 70.

If the flow table of switch Sw1 is controlled by an external controller 70 (e.g. an OpenFlow switch which is controlled by an OpenFlow controller) then the controller can keep the backup flow table 60. When the network equipment, i.e. switch Sw1, runs out of flow entry memory, which is communicated to the controller 70 via control channel 80, the controller 70 deletes the primary flow entries of the switch Sw1 and saves the secondary flow entries that it computed beforehand into the switch Sw1.

The controller 70 can either calculate a corresponding backup flow table 60 in parallel to calculating the primary flow table 50, or can do this on demand, i.e., when network equipment runs out of memory. The controller 70 can either proactively monitor the network equipment to detect a low memory state, or can be requested by the network equipment to replace a certain number or all primary flow entries.

The controller 70 can coordinate the activation of backup flow tables 60 for all controlled devices, e.g., by performing a synchronized activation. For instance, in connection with the embodiment of FIG. 5, the controller 70 may activate backup flow tables 60 for all switches Sw1-Sw4 in a synchronized fashion.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. Method for operating a flow-based switching system in a network, including at least one network node designed to transport incoming network packets, in particular a switch (20) or a router, wherein said incoming network packets are matched to flows according to predefined policies, wherein a dynamic flow table (40)—primary flow table (50)—containing information about said flows' properties is computed inside said network node or externally and stored in a memory of said network node,
wherein another dynamic flow table (40)—backup flow table (60)—is computed and maintained in parallel,
wherein said backup flow table (60) is more coarse grained than said primary flow table (50), and
wherein said network node switches between employing said primary flow table (50) or said backup flow table (60) depending on the status of predefined observables.

2. Method according to claim 1, wherein the process of switching from said primary flow table (50) to said backup flow table (60) is triggered by an event of reaching a predefined threshold value indicating exhaustion of any of said predefined observables.

3. Method according to claim 1, wherein the process of switching from said primary flow table (50) to said backup flow table (60) is triggered by an event indicating an expected degradation of network and/or service performance caused by the amount of flows being redirected to a network node-internal or external processing function with restricted computing power.

4. Method according to claim 1, wherein said backup flow table (60) is activated in case said memory and/or other local flow-related resource constraints prevent said network node from operating with said primary flow table (50).

5. Method according to claim 1, wherein said backup flow table (60) is stored in the same memory area of said memory as the primary flow table (50), wherein flow entries of said backup flow table (60) are given a lower priority than the flow entries of said primary flow table (50).

6. Method according to claim 5, wherein switching between an operation employing said primary flow table (50) and an operation employing said backup flow table (60) is performed by raising the priority of the flow entries of said backup flow table (60) above the priority of the flow entries of said primary flow table (50).

7. Method according to claim 1, wherein said primary flow table (50) is stored in a first memory area of said memory and wherein said backup flow table (60) is stored in a different second memory area of said memory.

8. Method according to claim 7, wherein switching between an operation employing said primary flow table (50) and an operation employing said backup flow table (60) is performed by deleting said primary flow table (50) from said first memory area of said memory and by copying said backup flow table (60) from said second memory area to said first memory area of said memory.

9. Method according to claim 1, wherein the activation and/or deactivation of said backup flow table (60) is triggered by a centralized controller, by a remote network node or by a neighbor network node.

10. Method according to claim 1, wherein said primary flow table (50) is controlled by an external controller, which keeps said backup flow table (60).

11. Method according to claim 10, wherein said external controller forces all network nodes within a network domain to perform coordinated switching from said primary flow tables (50) to said backup flow tables (60), or vice versa.

12. Method according to claim 1, wherein the calculation of said backup flow table (60) is performed per network node, per group of network nodes, or for said network as a whole.

13. Method according to claim 1, wherein said backup flow table (60) is pushed to a network node upon request and/or trigger events.

14. Method according to claim 13, wherein said pushing is performed proactively.

15. Method according to claim 1, wherein said backup flow table (60) is designed such that one flow entry of said backup flow table (60) substitutes and/or aggregates several flow entries of said primary flow table (50).

16. Method according to claim 1, wherein in said backup flow table (60) different QoS classes are summarized to a single QoS class.

17. Method according to claim 1, wherein flow entries, which result from said network node performing load balancing and/or least cost route optimization, are removed from said backup flow table (60).

18. Flow-based switching system, including at least one network node designed to transport incoming network packets, in particular a switch (20) or a router, wherein said system comprises
computation means for matching incoming network packets to flows according to predefined policies and for computing a dynamic flow table (40)—primary flow table (50)—containing information about said flows' properties, and
a memory for storing said primary flow table (50), wherein said system further comprises
computation means for computing another dynamic flow table (40)—backup flow table (60)—, which is maintained in parallel, wherein said backup flow table (60) is more coarse grained than said primary flow table (50), and
decision means for performing a switching between an operational state in which said primary flow table (50) is employed and an operational state in which said backup flow table (60) is employed, depending on the status of predefined observables.

19. System according to claim 18, wherein said memory includes a first memory area for storing said primary flow table (50), and a second memory area for storing said backup flow table (60).

20. System according to claim 18, wherein said network node is an OpenFlow switch.

21. System according to claim 18, including a controller (70), which keeps said backup flow table (60) and which communicates with said at least one network node via a control channel (80).

22. System according to claim 21, wherein said controller (70) is an OpenFlow controller.

23. System according to claim 18, wherein said computation means are part of said at least one network node or embedded in said controller (70).
